(19) United States
(12) Patent Application Publication
(10) Pub. No.: US 2006/0238784 A1
(43) Pub. Date: Oct. 26, 2006

(54) Image processing apparatus using multi-level halftoning and method thereof

(76) Inventor: Hae-kee Lee, Suwon-si (KR)

Correspondence Address: STANZIONE & KIM, LLP, 919 18TH STREET, N.W., SUITE 440, WASHINGTON, DC, 20006, US

(21) Appl. No.: 11/349,899

(22) Filed: Feb. 9, 2006

(30) Foreign Application Priority Data
Apr. 20, 2005 (KR) 2005-0032729

(51) Int. Cl. H04N 1/60

(52) U.S. Cl. 358/1.9; 358/3.06

(57) ABSTRACT

An image processing apparatus includes a level estimator to estimate whether a pixel value of each pixel of the input image is included in a predetermined threshold value range corresponding to an intermediate level, a pixel value setting part to set each pixel of the output image, which corresponds to the pixel of the input image included in the threshold value range, to have a pixel value corresponding to the intermediate level with uniform offset positions of dots to be formed corresponding to the pixels, and a pixel value modifier to modify the pixel value of at least one pixel of the output image estimated as the intermediate level to make the dots formed by the pixel adjacent to the dot of a neighboring pixel.

### CROSS-REFERENCE TO RELATED APPLICATIONS

This application claims the benefit of Korean Patent Application No. 2005-0032729, filed on April 20, 2005, in the Korean Intellectual Property Office, the disclosure of which is incorporated herein by reference.

### BACKGROUND OF THE INVENTION

1. Field of the Invention

The present general inventive concept relates to an image processing method and an image processing apparatus, and more particularly, to an image processing method and an image processing apparatus, in which a banding phenomenon is reduced in multilevel digital halftoning, to improve picture quality, and a method thereof.

2. Description of the Related Art

Digital halftoning is a method for creating a binary image (i.e., black and white), from an image having various brightness levels, (e.g., from a photograph scanned by a scanner, a computer graphic, or the like), which are referred to as a “continuous tone image.” Although an image having a halftone (hereinafter, referred to as a “halftone image”) is represented in only black and white, a human's eye recognizes the halftone image as an image having continuous shades of gray or a continuous gray level because the halftone image is spatially designed to appeal to interaction between visual sensation and brain operation.

As an image forming apparatus, such as a printer capable of printing a plurality of gray levels, has recently been developed, various research into developing a multilevel halftoning algorithm has been carried out. The multilevel halftoning is extended from bi-level or bi-tonal halftoning, and represents an intermediate tone using spatial modulation of two or more tones (i.e., black, white and one or more shades of gray).

However, the conventional multilevel halftoning has a problem in that a printed image has an undesirable texture around intermediate gray levels, which is called a “banding phenomenon.” FIG. 1A illustrates an image having the banding phenomenon. As illustrated in FIG. 1A, bands appears in the middle of the image, (i.e., around the intermediate gray levels). Therefore, gradation from white (refer to a left side of FIG. 1A) to black (refer to a right side of FIG. 1A) is likely to appear disrupted and unnatural. The reason why the banding phenomenon arises is because only dots having the intermediate gray levels appear in a region where color changes from white to black, and thus easily stand out to the human's eye.

To eliminate such a noticeable pattern, black and white dots can be added to the dots having the intermediate gray levels in the region corresponding to the intermediate gray levels. As an example of this technology, there is a Binar method. The Binar method includes 1) determining a mapping function in a region including a variable texture, 2) changing an input level of the mapping function corresponding to an input region, and 3) performing the halftoning using the changed input level. FIG. 1B illustrates an image modulated on the basis of the Binar method. As illustrated in FIG. 1B, the Binar method makes the black dots and the white dots appear in the modulated region adjacent to each other in a diagonal direction. Here, contrary to a method of compiling a general halftone table, values of a halftone table are adjusted while compiling the halftone table, so that the black dots and the white dots are adjacent to each other in the diagonal direction.

However, the conventional Binar method is effective in a halftone screen such as a dispersed-dot screen, but it is hard to apply the conventional Binar method to other types of halftone screens such as a clustered-dot screen. That is, the dots adjacent to each other should have both the low and high threshold values of the halftone table. However, in the case of the clustered-dot screen, the dots adjacent to each other have similar threshold values, and thus it is difficult to apply the Binar method to the clustered-dot screen.

### SUMMARY OF THE INVENTION

The present general inventive concept provides an image processing method and apparatus, in which pixels of an input image are estimated and set to an appropriate level depending on values of the corresponding pixels, and a method thereof so that a banding phenomenon is prevented regardless of patterns of a halftone screen, and picture quality is enhanced.

Additional aspects and/or advantages of the present general inventive concept will be set forth in part in the description which follows and, in part, will be obvious from the description, or may be learned by practice of the present general inventive concept.

The foregoing and/or other aspects of the present general inventive concept may be achieved by providing an image processing method of converting an input image of a continuous tone digital image into an output image, the method comprising estimating whether a pixel value of each pixel of an input image is included in a predetermined threshold value range corresponding to an intermediate level, setting each pixel of an output image, which corresponds to the each pixel of the input image included in the threshold value range, to have a second pixel value corresponding to the intermediate level with uniform offset positions of dots to be formed corresponding to adjacent pixels of the output image, and modifying the pixel value of at least one pixel of the output image estimated as the intermediate level to make the dots formed by the pixel adjacent to the dots of a neighboring pixel of the adjacent pixels of the output image.

The threshold value range may be determined by a threshold value corresponding to dots of a clustered-dot screen.

The threshold value range may also be determined by a threshold value corresponding to dots of a dispersed-dot screen.

The method may further comprise estimating whether the pixel value of each pixel of the input image estimated as the intermediate level is included in a modification processing range, wherein the modifying of the pixel value of the output image comprises modifying the pixel value of the output image corresponding to the pixel of the input image included in the modification processing range.

The modifying of the pixel value of the output image may comprise increasing a frequency of modifying the pixel value of the output image estimated as the intermediate level as the pixel value of the input image approaches an intermediate value of the intermediate level.

The modifying of the pixel value of the output image may further comprise calculating a frequency determination range to determine a frequency of modifying the pixel value of the output image on the basis of the pixel value of the input image, estimating whether an upper value or a lower value of the threshold value range is included in the frequency determination range, and modifying the pixel value of the output image corresponding to the pixel of the input image when the upper or lower value of the threshold value range is included in the frequency determination range.

The foregoing and/or other aspects of the present general inventive concept may also be achieved by providing an image processing apparatus to convert an input image of a continuous tone digital image into an output image, the apparatus comprising a level estimator to estimate whether a pixel value of a pixel of an input image is included in a predetermined threshold value range corresponding to an intermediate level, a pixel value setting part to set each pixel of an output image, which corresponds to each pixel of the input image included in the threshold value range, to have a second pixel value corresponding to the intermediate level with uniform offset positions of dots formed corresponding to the pixels of the output image; and a pixel value modifier to modify the pixel value of at least one pixel of the output image estimated as the intermediate level to make the dots formed by the pixel adjacent to the dots of a neighboring pixel of the adjacent pixels of the output image.

The foregoing and/or other aspects of the present general inventive concept may also be achieved by providing a computer readable medium containing executable code to convert an input image of a continuous tone digital image into an output image, the medium comprising a first executable code to estimate whether a pixel value of each pixel of the input image is included in a predetermined threshold value range corresponding to an intermediate level, a second executable code to set each pixel of the output image, which corresponds to each pixel of the input image included in the threshold value range, to have a second pixel value corresponding to the intermediate level with uniform offset positions of dots to be formed corresponding to adjacent pixels of the output image, and a third executable code to modify the pixel value of at least one pixel of the output image estimated as the intermediate level to make the dots formed by the pixel adjacent to the dots of a neighboring pixel of the adjacent pixels of the output image.

The foregoing and/or other aspects of the present general inventive concept may also be achieved by providing an image processing apparatus that modifies pixel values of pixels within an input image to create an output image, the apparatus comprising a level estimator to receive an input image, and determine whether pixel values of the input image correspond to a white level, a black level or an intermediate level, based on first and second threshold values, a pixel value setting part that sets the pixels of the input image individually to one of the white level, the black level and the intermediate level range based on the pixel values, and a pixel value modifier that modifies the pixels set to the intermediate level by changing dot positions of the pixels set to the intermediate level.

The foregoing and/or other aspects of the general inventive concept may also be achieved by providing a method of image processing an input image to create an output image, the method comprising receiving the input image, and determining whether pixel values of the input image correspond to a white level, a black level or an intermediate level, based on first and second threshold values, setting the pixels of the input image individually to one of the white level, the black level and the intermediate level range based on the pixel value, and modifying the pixels set to the intermediate level by changing dot positions of the pixels set to the intermediate level.

### BRIEF DESCRIPTION OF THE DRAWINGS

These and other aspects and advantages of the present general inventive concept will become apparent and more readily appreciated from the following description of the embodiments, taken in conjunction with the accompany drawings of which:

FIG. 1A illustrates a banding phenomenon arising in a multi-level halftone image in a conventional image processing apparatus;

FIG. 1B illustrates an image modulated by using a binary method in a conventional image processing apparatus.

FIG. 2 is a block diagram of an image processing apparatus according to an embodiment of the present general inventive concept;

FIG. 3 is a block diagram schematically illustrating a configuration of a printer driver of the image processing apparatus of FIG. 2;

FIG. 4A illustrates a halftone image processed by a conventional image processing apparatus;

FIG. 4B illustrates an image changed in an offset position, which is processed by the image processing apparatus of FIG. 2;

FIGS. 5A and 5B are enlarged views of portions of “A” and “B” in FIGS. 4A and 4B, respectively; and

FIG. 6 is a control flowchart of the image processing apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

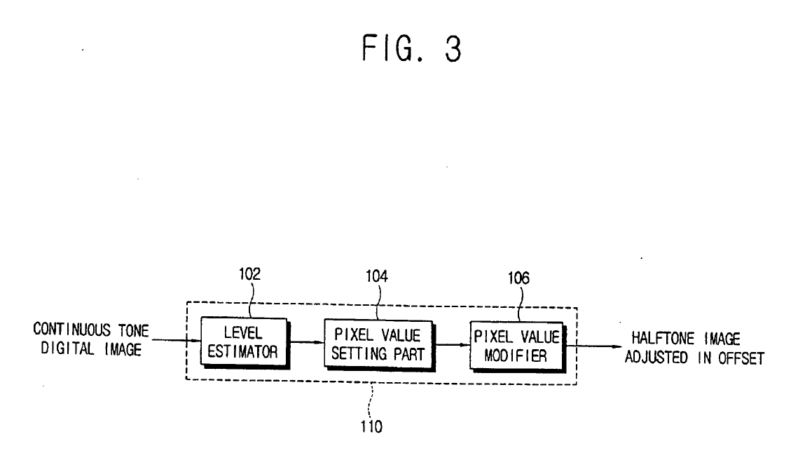

FIG. 2 is a block diagram of an image processing apparatus 100 according to an embodiment of the present general inventive concept. As illustrated in FIG. 2, the image processing apparatus 100 receives a continuous tone digital image, such as a photograph, a picture or the like, from a scanner 10, a digital camera 20, a computer system 30 or a network 40, and converts the continuous tone digital image into a halftone image having multilevels.

Alternatively, the image processing apparatus 100 may include a computer software program such as a text editor 120 or a graphics editor 130. In this case, the image processing apparatus 100 receives a continuous tone text or graphic image from the computer software program, and converts the continuous tone text or graphic image into a multilevel halftone image. Further, the image processing apparatus 100 may receive the continuous tone text or graphic image from the computer system 30 provided with the computer software program such as the text editor 120 or the graphics editor 130.

Alternatively, the image processing apparatus 100 may receive a continuous tone image from a network system 40 such as the Internet or other type of communication network, and convert the continuous tone image into the multilevel halftone image.

The image processing apparatus 100 according to the present embodiment includes a printer driver 110 to convert the received continuous tone image into the multilevel halftone image. The printer driver 110 converts the processed halftone image into data having a format acceptable to an image forming apparatus 200, and outputs the print data to the image forming apparatus 200.

The image forming apparatus 200 according to the present embodiment receives the print data from the image processing apparatus 100, and prints an image on a predetermined recording medium such as paper or the like or another type of recording medium, on the basis of the received print data. Here, the image forming apparatus 200 may include, for example, an inkjet printer, a laser printer, and a thermal printer.

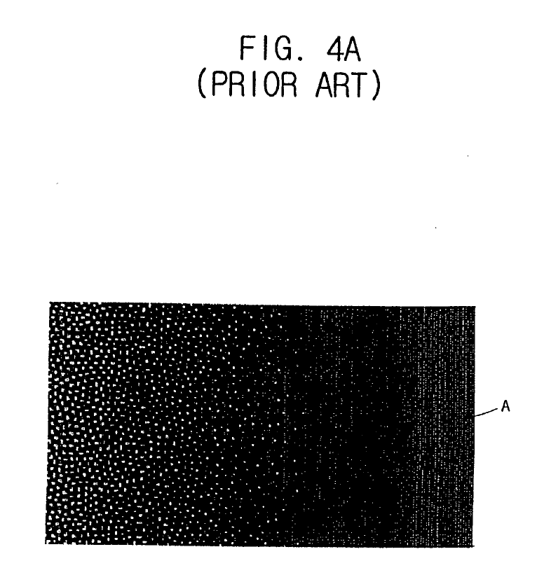

FIG. 3 is a block diagram schematically illustrating a configuration of the printer driver 110 of FIG. 2. As illustrated in FIG. 3, the printer driver 110 includes a level estimator 102, a pixel value setting part 104 and a pixel value modifier 106. The level estimator is used to estimate whether a pixel of a continuous-tone digital image (hereinafter, referred to as an “input image”) has a pixel value corresponding to an intermediate level among the multilevels of the halftone image. The pixel value setting part 104 is used to set pixels of the input image and output the set input image (hereinafter, referred to as an “output image”), which will be output corresponding to the pixels of the input image estimated with respect to the intermediate level to have pixel values that correspond to the intermediate level, in order to unify offset positions of dots formed corresponding to the pixels. The pixel value modifier 106 is used to modify the pixel values of the output image, which were estimated based on the intermediate level, and thus make formed dots adjoin adjacent dots.

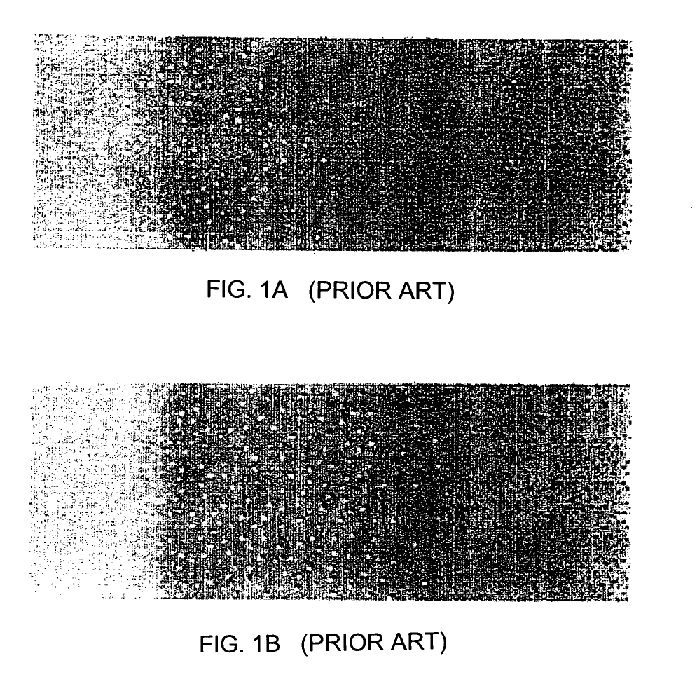

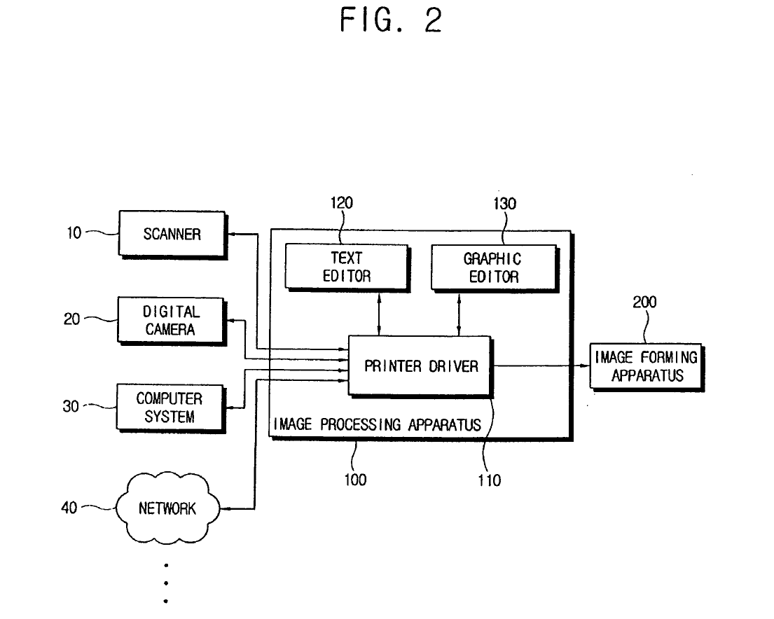

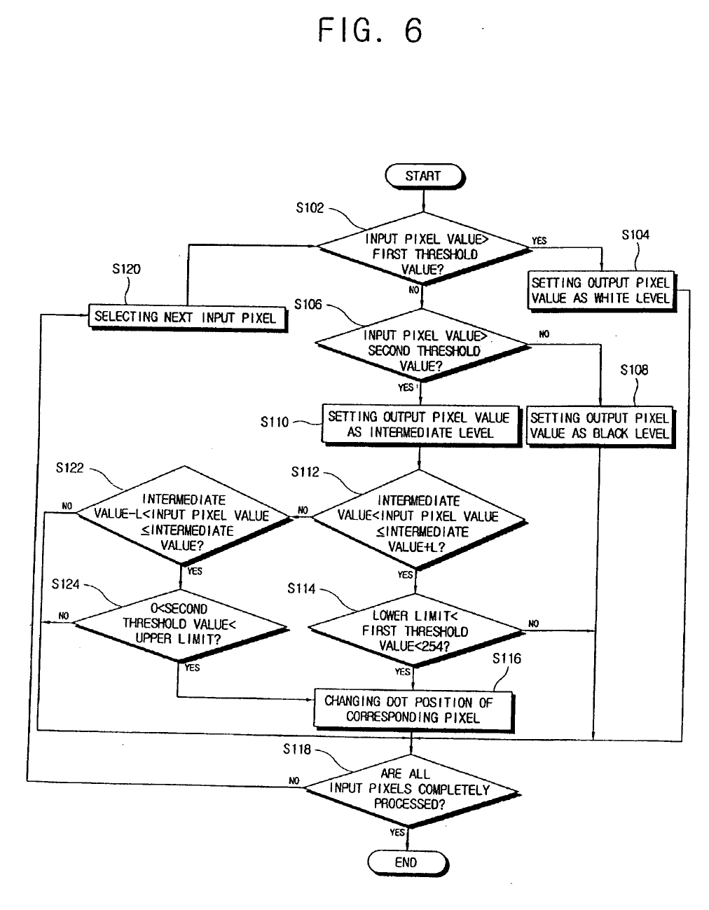

Operations of the image processing apparatus according to embodiments of the present general inventive concept will be described with reference to FIG. 6 which illustrates a control flowchart of the image processing apparatus 100. The image processing apparatus 100 of FIG. 1 converts the continuous tone image into a halftone image having three levels, e.g., a white level, a black level and an intermediate level or intermediate gray level.

Referring to FIGS. 2, 3 and 6, at operation S102, the level estimator 102 determines whether each pixel of the input image has a pixel value larger than a predetermined first threshold value. Here, the first threshold value may be a threshold value of each dot of a halftone screen such as a clustered-dot screen a dispersed-dot screen, etc. For example, when the continuous-tone image having a level ranging from ‘0’ to ‘255’ is processed by three-level halftoning, the image processing apparatus 100 provides a first halftone screen corresponding to a level ranging from ‘0’ to ‘127’ and a second halftone screen corresponding to a level ranging from ‘128’ to ‘255’, and compares the pixel values of the input image with each threshold value of the two halftone screens. Then, the image processing apparatus 100 determines whether each pixel value of the pixels of the input image is included in a predetermined threshold value range corresponding to the intermediate level. In this case, the threshold value of the halftone screen corresponding to the level ranging from ‘128’ to ‘255’ can be used as the first threshold value. However, the first threshold value may be represented by an individual value within the range of 128-255, for example, the first threshold value may be 253.

In this embodiment, the white level may be ‘255’, and the black level may be ‘0.’ When the level estimator 102 determines that the input image has a pixel value larger than the first threshold value (refer to “YES” of the operation S102), the pixel value setting part 104 sets the pixel value of the corresponding output image as the white level at operation S104. Then, at operation S118, the level estimator 102 checks whether all input pixels are completely processed. When the level estimator 102 determines that all input pixels are not completely processed (refer to “NO” of the operation S118), the level estimator 102 selects the next pixel of the input image at operation S120, and then determines whether the selected next pixel of the input image has a pixel value larger than the first threshold value at operation S102.

On the other hand, when the level estimator 102 determines that the selected input image has a pixel value smaller than the first threshold value at operation S102 (refer to “NO” of the operation S102), it determines whether the selected input image has a pixel value smaller than a second threshold value at operation S106. In this case, the threshold value of the halftone screen corresponding to the level ranging from ‘0’ to ‘127’ can be used as the second threshold value. However, the second threshold value may be represented by an individual value within the range of 0-127, for example, the first threshold value may be 5. When the level estimator 102 determines that the input image has a pixel value smaller than the second threshold value (refer to “NO” of the operation S106), the pixel value setting part 104 sets the pixel value of the corresponding output image as the black level at operation S108. Then, at operation S118, the level estimator 102 checks whether all input pixels are completely processed. When the level estimator 102 determines that all input pixels are not completely processed (refer to “NO” of the operation S118), the level estimator 102 selects the next pixel of the input image at operation S120, and determines whether the selected input image has a pixel value larger than the first threshold value at operation S102. In this case, the first and second threshold values were described as an example of an upper value and a lower value, respectively.

On the other hand, when the level estimator 102 determines that the pixel value of the input image is greater than the second threshold value (refer to “YES” of the operation S106), the pixel value setting part 104 sets the pixel value of the corresponding output image as an intermediate level at operation S110. In this case, the pixel value setting part 104 sets the pixel value of the output image so as to unify the offset position of dots formed corresponding to the respective pixels of the output image. The pixel value setting part 104 can change a pulse offset position by a pulse width modulation method, and select positions of the dots formed within one pixel on the basis of the pixel value. For instance, the pixel value setting part 104 sets the pulse offset position in a right direction, so that a right half of one pixel is filled with one or more black dots, and the other half is left blank.

At operation S112, the pixel value modifier 106 determines whether the pixel value of the input pixel estimated as the intermediate level is larger than an intermediate value of the intermediate level and smaller than or equal to a value obtained by adding a predetermined range value “L” to the intermediate value. The intermediate value can be ‘128’ as half of ‘256’ levels. The range value “L” is set as a proper value needed to modify the pixel value. That is, the range value “L” is set in consideration of a range where it is experimentally determined that the banding phenomenon arises. For example, the range value “L” may be set as ‘10.’

When the pixel value modifier 106 determines that the pixel value of the input pixel estimated as the intermediate level is larger than the intermediate value of the intermediate level and smaller than the value obtained by adding the range value “L” to the intermediate value (refer to “YES” of the operation S112), the pixel value modifier 106 determines whether the first threshold value of the corresponding pixel is larger than a predetermined lower limit and smaller than ‘254’ at operation S114 in the case that the halftone screen is the clustered-dot screen. When the pixel value modifier 106 determines that the pixel value of the input pixel estimated as the intermediate level is included in the range requiring the modifying process, the frequency of modifying the pixel value of the corresponding output image can increase as the pixel value of the input pixel approaches the intermediate value. That is the operation of modifying the pixel value may be repeated until the pixel value is changed to a value corresponding to the intermediate value which can be set. In this case, the lower limit of the input pixel can be defined as a function of the pixel value, and the lower limit can decrease as the pixel value of the input pixel approaches the intermediate value. For example, in the case that the halftone screen is the clustered-dot screen, the lower limit=238+2*(input pixel value−127). In this example, the range from the lower limit to ‘254’ is used as a frequency determination range by way of an example.

Alternatively, when the pixel value modifier 106 determines that the pixel value of the input pixel estimated as the intermediate level is larger than the intermediate value of the intermediate level and smaller than the value obtained by adding the range value “L” to the intermediate value (refer to “YES” of the operation S112), the pixel value modifier 106 may determine whether the first threshold value corresponding to the pixel is, for example, larger than ‘0’ and smaller than ‘18’ in the case that the halftone screen is the dispersed-dot screen.

When the pixel value modifier 106 determines that the first threshold value corresponding to the pixel is larger than the lower limit and smaller than ‘254’ (refer to “YES” of the operation S114), the offset position of the dots are changed to make the dots of the corresponding pixel adjoin the dots of the adjacent pixel. In this case, the pixel value modifier 106 sets the offset position of the dot of the corresponding pixel in the left or right direction, so that the corresponding dots can adjoin the dots of the adjacent pixel at operation S116. For example, in the case where the input pixel has a pixel value of ‘134’, the pixel having a first threshold level of 253 in the halftone table is changed in the offset position of the dots.

When the pixel value modifier 106 determines that the first threshold value corresponding to the pixel is not larger than the lower limit or not smaller than ‘254’ (refer to “NO” of the operation S114), the level estimator 102 checks whether all input pixels are completely processed. When the level estimator 102 determines that all input pixels are not completely processed (refer to “NO” of the operation S118), the level estimator 102 selects the next pixel of the input image at operation S120, and determines whether the selected input image has a pixel value larger than the first threshold value at operation S102.

When the pixel value modifier 106 determines that the pixel value of the input pixel estimated as the intermediate level is not larger than the intermediate value of the intermediate level or not smaller than or equal to the value obtained by adding the range value “L” to the intermediate value (refer to “NO” of the operation S112), That is the pixel value is not within a range between the intermediate value and the value obtained by adding the rang value “L” to the intermediate value, the pixel value modifier 106 determines whether the pixel value of the input pixel estimated as the intermediate level is larger than a value obtained by subtracting the range value “L” from the intermediate value and smaller or equal to the intermediate value at operation S122.

When the pixel value modifier 106 determines that the pixel value of the input pixel estimated as the intermediate level is larger than the value obtained by subtracting the range value “L” from the intermediate value and smaller than or equal to the intermediate value (refer to “YES” of the operation S122), the pixel value modifier 106 determines whether the second threshold value of the corresponding pixel is larger than ‘0’ and smaller than a predetermined upper limit at operation S124 in the case that the halftone screen is the clustered-dot screen. In this case, the pixel value modifier 106 sets the frequency of modifying the pixel value of the corresponding output image to increase as the pixel value of the input pixel approaches the intermediate value. In this case, the upper limit may be a function decreasing as the pixel value of the input pixel approaches the intermediate value. For example, in the case that the halftone screen is the clustered-dot screen, the upper limit=2*(input pixel value−120). In this example, the range from ‘0’ to the upper limit is used as an example of the frequency determination range. Likewise, the range from ‘intermediate value−L’ to ‘intermediate value+L’ may be used as an example of the frequency determination range.

Alternatively, when the pixel value modifier 106 determines that the pixel value of the input pixel estimated as the intermediate level is larger than the value obtained by subtracting the range value “L” from the intermediate value, and smaller than or equal to the intermediate value (refer to “YES” of the operation S122), the pixel value modifier 106 may determine whether the second threshold value corresponding to the pixel is larger than ‘242’ and smaller than the ‘input pixel value*2’ in the case that the halftone screen is the dispersed-dot screen.

When the pixel value modifier 106 determines that the second threshold value of the corresponding pixel is larger than ‘0’ and smaller than the upper limit (refer to “YES” of the operation S124), the offset position of the dots are changed to make the dots of the corresponding pixel adjoin the dots of the adjacent pixel.

When the pixel value modifier 106 determines that the second threshold value corresponding to the pixel is larger than ‘0’ and greater than the upper limit (refer to “NO” of the operation S124), that is, the pixel value is not within a range between the intermediate value and the value obtained by subtracting the range value “L” from the intermediate value, the level estimator 102 checks whether all input pixels are completely processed. When the level estimator 102 determines that all input pixels are not completely processed (refer to “NO” of the operation S118), the level estimator 102 selects the next pixel of the input image at operation S120, and determines whether the selected input image has a pixel value larger than the first threshold value at operation S102. On the other hand, when the level estimator 102 determines that all input pixels are completely processed (refer to “YES” of the operation S118), the image processing apparatus 110 stops operating.

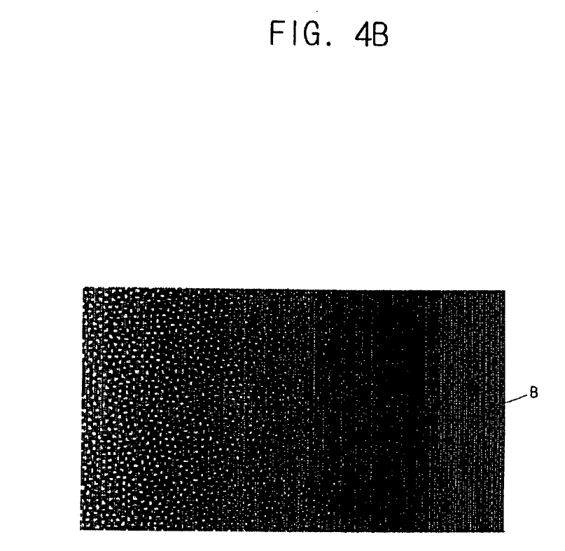

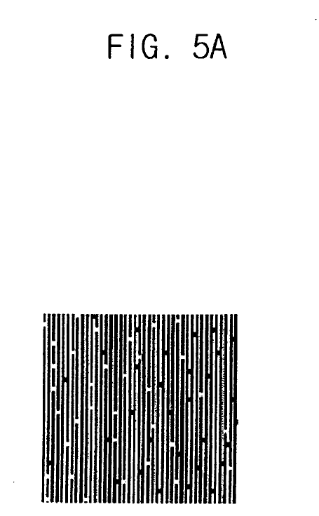

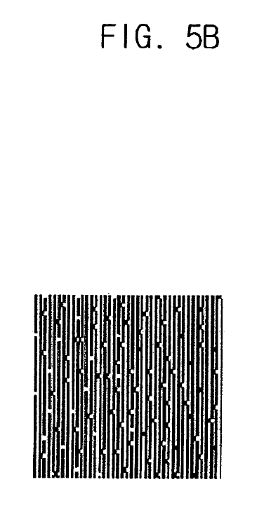

FIG. 4B illustrates an image changed in an offset position, which is processed by the image processing apparatus according to an embodiment of the present general inventive concept, and FIG. 5B is an enlarged view of “B” of FIG. 4B. The halftone screen illustrated in FIGS. 4B and 5B is the dispersed-dot screen. On the other hand, FIG. 4A illustrates a halftone image of a conventional image processing apparatus, and FIG. 5A is an enlarged view of “A” of FIG. 4. As illustrated in FIGS. 4B and 5B, when the offset position of the dots corresponding to the intermediate level is changed by the image processing apparatus according to an embodiment of the present general inventive concept, pairs of black and white pixels are formed. Therefore, the black or white dot is changed in the unified offset position and adjoins the adjacent dots, so that the images visually appear as the black and white pixels, and thus the bending phenomenon may be decreased.

The conventional method, described previously, modifies the pixel value of the input pixel using a mapping function, but the method according to the present embodiment uses the halftone table within a predetermined range without using the mapping function. Further, only the offset position of the dot is changed, so that the black and white dots are formed without changing the representation of the gray level. Therefore, the black and white dots are formed adjacent to each other similar to the conventional Binar method. Also, according to an embodiment of the present general inventive concept, the frequency of displaying the black and white dots increased as compared with the conventional method (refer to FIGS. 4A and 5A).

Further, contrary to the conventional Binar method, the method according to the present embodiment is not limited to the patterns of the halftone screen, and can employ the clustered-dot screen. Also, the positions of the black and white dots in the halftone screen are not required to be previously set.

The image processing apparatus 100, according to an example embodiment of the present general inventive concept can be achieved by a general computer system, and may include, for example, a microprocessor, a random access memory (RAM), and a hard disk drive. Further, the printer driver 110 according to an example embodiment of the present general inventive concept can be achieved by computer software programs programmed in the microprocessor, and by implementing the respective operations of the level estimator 102, the pixel value setting part 104 and the pixel value modifier 106. In this example, the hard disk drive may store the computer software program to implement the operations, and thus the printer driver 110 loads the computer software program into the RAM in response to a predetermined instruction and performs the operations under commands of the computer software program.

In the foregoing embodiments, the halftone image has three levels, but should not be limited thereto, and may have multi-levels provided the image forming apparatus 200 can accommodate them. Further, the level estimator 102, the pixel value setting part 104 and the pixel value modifier 106 of the image processing apparatus 100 may be included in the image forming apparatus 200 having an image forming unit to print the output image according to information on the dot positions of the pixels and the halftone values.

The embodiments of the present general inventive concept can be embodied as computer readable codes on a computer readable recording medium. The computer readable recording medium may include any data storage device that can store data which can be thereafter read by a computer system. Examples of the computer readable recording medium include a read-only memory (ROM), a random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. The embodiments of the present general inventive concept may also be embodied in hardware or a combination of hardware and software.

As described above, the present general inventive concept provides an image processing method and an image processing apparatus, in which a banding phenomenon is reduced regardless of patterns of a halftone screen, thereby enhancing picture quality.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image processing method of converting an input image of a continuous tone digital image into an output image, the method comprising:
estimating whether a pixel value of each pixel of an input image is included in a predetermined threshold value range corresponding to an intermediate level;
setting each pixel of an output image, which corresponds to each pixel of the input image included in the threshold value range, to have a second pixel value corresponding to the intermediate level with uniform offset positions of dots to be formed corresponding to adjacent pixels of the output image; and
modifying the pixel value of at least one pixel of the output image estimated as the intermediate level to make the dots formed by the pixel adjacent to the dots of a neighboring pixel of the adjacent pixels of the output image.

2. The method according to claim 1, wherein the threshold value range is determined by a threshold value corresponding to dots of a clustered-dot screen.

3. The method according to claim 1, wherein the threshold value range is determined by a threshold value corresponding to dots of a dispersed-dot screen.

4. The method according to claim 1, further comprising:
estimating whether the pixel value of each pixel of the input image estimated as the intermediate level is included in a modification processing range,
wherein the modifying of the pixel value of the output image comprises modifying the pixel value of the output image corresponding to the pixel of the input image included in the modification processing range.

5. The method according to claim 1, wherein the modifying of the pixel value of the output image comprises increasing a frequency of modifying the pixel value of the output image estimated as the intermediate level as the pixel value of the input image approaches an intermediate value of the intermediate level.

6. The method according to claim 1, wherein the modifying the pixel value of the output image comprises:
calculating a frequency determination range to determine a frequency of modifying the pixel value of the output image on the basis of the pixel value of the input image;
estimating whether an upper value or a lower value of the threshold value range is included in the frequency determination range; and
modifying the pixel value of the output image corresponding to the pixel of the input image when the upper or lower value of the threshold value range is included in the frequency determination range.

7. An image processing apparatus to convert an input image of a continuous tone digital image into an output image, the apparatus comprising:
a level estimator to estimate whether a pixel value of a pixel of an input image is included in a predetermined threshold value range corresponding to an intermediate level;
a pixel value setting part to set each pixel of an output image, which corresponds to each pixel of the input image included in the threshold value range, to have a second pixel value corresponding to the intermediate level with uniform offset positions of dots formed corresponding to the pixels of the output image; and
a pixel value modifier to modify the pixel value of at least one pixel of the output image estimated as the intermediate level to make the dots formed by the pixel adjacent to the dots of a neighboring pixel of the adjacent pixels of the output image.

8. The image processing apparatus according to claim 7, wherein the threshold value range is determined by a threshold value corresponding to dots of a clustered-dot screen.

9. The image processing apparatus according to claim 7, wherein the threshold value range is determined by a threshold value corresponding to dots of a dispersed-dot screen.

10. The image processing apparatus according to claim 7, wherein the level estimator further estimates whether the pixel value of each pixel of the input image estimated as the intermediate level is included in a modification processing range, and the pixel value modifier further modifies the pixel value of the output image corresponding to the pixel of the input image included in the modification processing range.

11. The image processing apparatus according to claim 7, wherein the pixel value modifier further modifies the pixel value of the output image by increasing a frequency of modifying the pixel value of the output image estimated as the intermediate level as the pixel value of the input image approaches an intermediate value of the intermediate level.

12. The image processing apparatus according to claim 7, wherein the pixel value modifier:
calculates a frequency determination range to determine a frequency of modifying the pixel value of the output image on the basis of the pixel value of the input image;
estimates whether an upper value or a lower value of the threshold value range is included in the frequency determination range; and
modifies the pixel value of the output image corresponding to the pixel of the input image when the upper or lower value of the threshold value range is included in the frequency determination range.

13. A computer readable medium containing executable code to convert an input image of a continuous tone digital image into an output image, the medium comprising:
a first executable code to estimate whether a pixel value of each pixel of the input image is included in a predetermined threshold value range corresponding to an intermediate level;
a second executable code to set each pixel of the output image, which corresponds to each pixel of the input image included in the threshold value range, to have a second pixel value corresponding to the intermediate level with uniform offset positions of dots to be formed corresponding to adjacent pixels of the output image; and
a third executable code to modify the pixel value of at least one pixel of the output image estimated as the intermediate level to make the dots formed by the pixel adjacent to the dots of a neighboring pixel of the adjacent pixels of the output image.

14. An image processing apparatus that modifies pixel values of pixels within an input image to create an output image, the apparatus comprising:
a level estimator to receive an input image, and to determine whether pixel values of the input image correspond to a white level, a black level or an intermediate level, based on first and second threshold values;
a pixel value setting part that sets the pixels of the input image individually to one of the white level, the black level and the intermediate level range based on the pixel values; and
a pixel value modifier that modifies the pixels set to the intermediate level by changing dot positions of the pixels set to the intermediate level.

15. The image processing apparatus of claim 14, wherein the pixel value modifier further determines whether the pixel values set to the intermediate level are within a frequency determination range that spans from ‘0’ to an upper limit value defined by a function that decreases as one or more pixel values of the input image approaches the intermediate value.

16. A method of image processing an input image to create an output image, the method comprising:
receiving the input image and determining whether the pixel values of the input image correspond to a white level, a black level or an intermediate level, based on first and second threshold values;
setting the pixels of the input image individually to one of the white level, the black level and the intermediate level range based on the pixel values; and
modifying the pixels set to the intermediate level by changing dot positions of the pixels set to the intermediate level.

17. The image processing apparatus of claim 14, further comprising:
an image forming unit to print the modified pixels according to information on the set pixels of the input image and the one or more changed dot positions of the modified pixels.

18. The image processing apparatus of claim 14, wherein the intermediate level is between the first and second threshold values.

19. The image processing apparatus of claim 14, wherein the pixel value modifier changes the one or more dot positions of the pixels set to the intermediate level according to upper and lower limits, wherein the upper and lower limits are between a white value and an intermediate value and between a black value and the intermediate value, respectively.
